(19) United States
(12) Patent Application Publication
(10) Pub. No.: US 2005/0014070 A1
(43) Pub. Date: Jan. 20, 2005

(54) Nonaqueous electrolyte

(76) Inventors: Thirumalai G. Palanisamy, Morristown, NJ (US); Stephen E. LaCroix, Morristown, NJ (US); Alfred AS Siggel, Hanover (DE); Michael Fooken, Seelze (DE)

Correspondence Address: HONEYWELL INTERNATIONAL INC., 101 COLUMBIA ROAD, P O BOX 2245, MORRISTOWN, NJ, 07962-2245, US

(21) Appl. No.: 10/800,948

(22) Filed: Mar. 15, 2004

Related U.S. Application Data
(60) Provisional application No. 60/455,256, filed on Mar. 17, 2003.
(60) Provisional application No. 60/549,083, filed on Mar. 1, 2004.

(51) Int. Cl. H01M 10/40; H01M 4/58

(52) U.S. Cl. 429/326; 429/329; 429/231.8

(57) ABSTRACT

A non-aqueous electrolyte for an electrical storage device comprising a non-aqueous solvent, a salt dissolved in said non-aqueous solvent, and a liquid viscosity reducing agent in sufficient quantity to substantially reduce the viscosity of the electrolyte below the viscosity of the non-aqueous solvent.

### REFERENCE TO RELATED APPLICATIONS

This application claims the priority of U.S. Provisional Application No. 60/455,256 filed on Mar. 17, 2003, and Provisional Application No. 60/549,083 filed on Mar. 1, 2004, both of which are hereby incorporated by reference.

### FIELD OF INVENTION

The present invention relates generally to non-aqueous electrolytes useful in electrical energy storage devices, and, more specifically, to non-aqueous electrolytes for use in supercapacitors.

### BACKGROUND OF INVENTION

Significant effort has been invested over the years in improving the energy and power of electrical energy storage devices such as capacitors and batteries. Of particular interest herein are supercapictors. These energy storage devices are particularly useful in short term, high energy change rate applications such as electric vehicles or cellular communication. A typical supercapacitor comprises carbon-based electrodes and an electrolyte having charged ions which can be ordered about the electrodes to create a potential between the electrodes. Therefore, critical to the overall performance of a supercapacitor is its electrolyte.

An electrolyte typically comprises an ionic salt dissolved in a solvent. A wide variety of solvents and salts are available for such use, offering specific advantages depending on the application being considered (e.g., low temperature vs. high temperature). Generally, non-aqueous electrolytes are preferred from the standpoint of electrochemical stability and are considered herein in detail. A common nonaqueous electrolyte comprises a salt, e.g., tetraethyl ammonium tetrafluoroborate (TEABF4), dissolved in an organic solvent, e.g., acetonitrile (AN), propylene carbonate (PC) or gamma butyrolactone (GBL).

From a performance standpoint, TEABF4 dissolved in AN is the most preferred electrolyte. However, it is not generally accepted since it can release dangerous hydrogen cyanide gas when ignited. For this reason, electrolytes of TEABF4 dissolved in other harmless solvents like PC or GBL are generally preferred. Unfortunately, the performance of these electrolytes tends to suffer, especially at low temperatures, due to their relative low conductivity.

Good conductivity of the electrolyte is critical for the supercapacitors to have low internal resistance or equivalent series resistance. The conductivity is generally affected by both salt and solvent characteristics, mainly those that affect solubility limit and mobility of the ions. Dielectric constant, viscosity, freezing and boiling points and density are some of the important properties of the solvent that affect the performance. Freezing point and viscosity may affect the low temperature performance. Applicants have found that with most electrolytes, conductivity is inversely proportional to the viscosity of the solvent. For example, at 1 molar concentration TEABF4/PC has a conductivity of around 12 mS/cm compared to over 50 mS/cm in the case of acetonitrile and 18 mS/cm in the case of GBL using the same salt. On examining this relationship, applicants recognized that if viscosity of the electrolyte is reduced, conductivity of the electrolyte can be improved.

U.S. Pat. No. 5,965,054 discloses using low viscosity agents, specifically, gasses (e.g., CO₂, NO₂, N₂O, etc.) to improve performance, especially at lower temperatures. Applicants have identified, however, a number of shortcomings associated with using gases as viscosity reducing agents. Perhaps the most significant problem is the tendency for gases to come out of solution as the electrolyte is heated. That is, gas viscosity reducing agents are not robust in the sense that, as the electrolyte is exposed to a typical thermal cycle, the gases tend to leave the solution at the high temperatures and, thus, are unavailable as a viscosity reducing agent when the electrolyte cycles through low temperatures. Additionally, the use of gases in the electrolyte introduces complications in packaging the electrical storage device. This is particularly problematic if the gases leave solution at high temperatures and thus create increased pressure within the device. Furthermore, the gases disclosed in the '054 patent are not inert. Consequently, some side reaction with either the electrolyte or electrodes in the device can be expected. Such side reactions tend to diminish the performance of the electrolyte in the device and, thus, are undesirable.

Therefore, there is a need for an electrolyte which has good performance at low temperatures but which is robust through a wide thermal operating range. The present invention fills this need among others.

### SUMMARY OF INVENTION

The present invention provides for an electrolyte having a liquid viscosity reducing agent which improves the performance of the electrolyte at low temperatures and is stable through a wide temperature range.

The use of a liquid viscosity reducing agents offers a number of important advantages over gas viscosity reducing agents. First, a liquid viscosity reducing agent is far less likely to leave solution than gas agents. Consequently, electrolytes having such liquid viscosity reducing agents tend to be stable over a wider temperature range. Second, liquid viscosity reducing agents are more easily handled and thus can be packaged into energy storage devices more readily compared to gas agents. The ease in handling and in packaging reduces costs and provides for more simple, robust energy storage devices. Third, since the liquid viscosity reducing agent adds volume to the electrolyte without sacrificing performance, it reduces cost substantially. The cost advantage comes mainly from the savings in the amount of the salt used in a given volume of the electrolyte since the cost of the salt (e.g., TEABF4) accounts for most of the electrolyte cost (90% in the case of TEABF4).

Accordingly, one aspect of the present invention is an electrolyte comprising a liquid viscosity reducing agent. In a preferred embodiment, the electrolyte comprises a nonaqueous solvent, a salt dissolved in said nonaqueous solvent, and a liquid viscosity reducing agent in sufficient quantity to substantially reduce the viscosity of the electrolyte below the viscosity of the nonaqueous solvent. Preferably, the liquid viscosity reducing agent is a C3 to C10 ketone, more preferably, pentanone, and, most preferably, 2-pentanone.

The use of 2-pentanone is preferred not only from the standpoint of improving the performance of the electrolyte system, but also from the standpoint of economy. That is, inexpensive, commercially-available 2-pentanone includes typically up to about 15% methyl isobutyl ketone (MIBK) as an impurity. It has been discovered unexpectantly, however, that the presence of MIBK does not diminish the effectiveness of 2-pentanone as a viscosity-reducing agent for an electrolyte and, in fact, MIBK appears to be almost equally beneficial to the overall performance of the electrolyte system. This is very unexpected since electrolyte systems tend to be susceptible to dramatic swings in performance for relatively slight chemistry variations. Therefore, the commercial 2-pentanone can be used as an additive without any further purification to eliminate MIBK. This is significant as the cost of impure 2-pentanone is considerably less than that of its purified form.

Therefore, another aspect of the present invention is an electrolyte comprising impure 2-pentanone. In a preferred embodiment, the electrolyte comprises a nonaqueous solvent, a salt dissolved in said nonaqueous solvent, and a viscosity reducing agent, said viscosity reducing agent comprising impure 2-pentanone in sufficient quantity to substantially reduce the viscosity of the electrolyte below the viscosity of the nonaqueous solvent. Preferably, the main impurity in the viscosity reducing agent is MIBK, which can be present in concentrations up to about 45% by volume.

The nonaqueous electrolytes of the present invention are useful in electrical energy storage devices, particularly electrochemical capacitors/supercapacitors. These electrolytes can also be used in potentiometric and voltametric electrochemical sensors, photovoltaic devices, fuel cells, and in primary and secondary batteries employing alkali and alkaline earth anode materials so long as the electrolyte contains the cation of the alkali or alkaline earth anode material. Further, the electrolytes of the invention will find use as media for catalysis or electrolysis.

Accordingly, another aspect of the present invention is an electrical energy storage device containing the electrolyte described above.

### BRIEF DESCRIPTION OF DRAWINGS

Other features and advantages of the invention will be apparent from the following detailed description of the invention, taken in conjunction with the accompanying drawings in which:

FIG. 1 shows the conductivity of various TEABF4/PC electrolytes with varying concentrations of 2-pentanone.

FIGS. 2-5 show the cyclic voltammetry of various TEABF4/PC electrolytes with varying concentrations of 2-pentanone.

FIG. 6 shows conductivities of various PyHBF4/PC electrolytes with varying concentrations of 2-pentanone.

FIG. 7 through 10 show cyclic voltammetry of various PyHBF4/PC electrolytes with varying concentrations of 2-pentanone.

FIG. 11 shows the conductivity of various TEABF4/GBL electrolytes with varying concentrations of 2-pentanone.

FIGS. 12 and 13 the cyclic voltammetry of various TEABF4/GBL electrolytes with varying concentrations of 2-pentanone.

FIG. 14 shows conductivities of various PyHBF4/GBL electrolytes with varying concentrations of 2-pentanone.

FIGS. 15A-15C show the cyclic voltammetry of an TEABF4/PC electrolyte, an TEABF4/PC electrolyte with pure 2-pentanone, and an TEABF4/PC electrolyte with impure 2-pentanone having 6% MIBK.

FIGS. 16A-16C show the cyclic voltammetry of the electrolytes of FIGS. 15A-15B after a CA test of 1.5V.

FIGS. 17A-17C show the cyclic voltammetry of the electrolytes of FIGS. 15A-15B after a CA test of −1.5V.

FIG. 18 shows the conductivity comparison for TEABF4 in PC with 2-pentanone having varying concentrations of MIBK.

FIG. 19 shows the cyclic voltammetry of the electrolyte comprised of 0.75 mol/l TEABF4 in PC/MIBK in the ratio of 90:10.

### DETAILED DESCRIPTION OF PREFERRED EMBODIMENTS

The present invention provides for an improved electrolyte by providing a liquid viscosity reducing agent which improves the electrolyte conductivity through a wide temperature range. In a preferred embodiment, the electrolyte comprises a nonaqueous solvent, a salt dissolved in said nonaqueous solvent, and a liquid viscosity reducing agent in sufficient quantity to substantially reduce the viscosity of the electrolyte below the viscosity of the nonaqueous solvent. Also in a preferred embodiment, the viscosity reducing agent is impure 2-pentanone. These components are considered below in greater detail. To facilitate understanding, the liquid viscosity reducing agent is described herein with particular reference to PC and GBL systems, although it should be understood that the invention is not limited to these systems and can be practiced with any traditional electrolyte system and new systems such as those described in Provisional Application No. 60/437,321 filed on Dec. 31, 2002, and the PCT application which is based upon it filed on Dec. 19, 2003, which are hereby incorporated by reference.

Since an electrolyte is a system of ions and solvent, the solvent is important and affects directly the performance of the electrolyte. Preferably, the non-aqueous solvent is an organic solvent. More preferably, the organic solvent is a linear ether, cyclic ether, ester, carbonate, formate, lactone, nitrile, dinitrile, amide, sulfone or sulfolane, and, even more preferably, is an alkyl carbonate, alkyl nitrile or alkyl lactone. In a particularly preferred embodiment, the solvent is propylene carbonate (PC), acetonitrile (AN), or gamma butyrolactone (GBL). Those solvents having a viscosity higher than 0.6 centipoise at room temperature stand to particularly benefit from a viscosity reducing agent of the present invention. Examples of suitable solvents include, for example, propylene carbonate (PC), acetonitrile (AN), or gamma butyrolactone (GBL), gamma valerolactone, propionitrile, glutaronitrile, adiponitrile, methoxyacetonitrile, 3-methoxypropionitrile, sulfolane. As mentioned above, the fact that AN can emit dangerous hydrogen cyanide gas when ignited militates against its use, and, in many countries, it is prohibited. Therefore, although AN may have better properties from an electrolyte performance standpoint, it is less preferred than PC and GBL due to safety issues. It may be preferable to use a combination of PC, AN and GBL for a particular application. Likewise, it may be preferable to use a combination of two or more non-aqueous solvents mentioned in the paragraph above for a particular application.

The salt must be capable of disassociating in the solvent such that its cation and anion can migrate within the solvent to their respective electrodes within the energy storage device. Suitable salts include combination of anions—such as perfluoro anions or perfluoro, organic sulfonates (e.g., PF6-, BF4-, AₛF6-, and triflate)—and cations—such as tetraethyl ammonium or methyl triethyl ammonium, or pyridinium. Preferred salts include, for example, tetraethyl ammonium tetrafluoroborate (TEABF4), methyl triethyl ammonium tetrafluoroborate (MTEABF4), pyridinium tetrafluoroborate (PyHBF4), tetraethyl ammonium hexafluorophosphate, tetramethylammonium hexafluorophosphate, tetraethyl ammonium trifluoromethylsulfonate, tetramethylammonium trifluoromethylsulfonate. Preferably, the salt is TEABF4, MTEABF4, or PyHBF4.

Suitable electrolytes must have high conductivity and good electrochemical stability. The power output capability of an energy storage device depends on the working voltage and the maximum current output capability of the electrolyte in combination with the electrodes. The working voltage is directly related to the electrolyte's electrochemical stability while the maximum current output (at least in the double layer type supercapacitors) is mainly dictated by the electrolyte's conductivity.

To evaluate an electrolyte's electrochemical stability, the electrolyte is subjected to cyclic voltammetry to determine its “voltage window.” As used herein, the term “voltage window” refers to the voltage range which the electrolyte can tolerate without substantially reacting (i.e., undergoing reduction or oxidation). To determine the voltage window, an electrolyte is placed in a cell having a working electrode, a counter electrode, and a test electrode, which is immediately adjacent but not touching the working electrode. The electrodes in the cell are connected to a cyclic voltammetry apparatus, called a potentiostat, which is configured to adjust the current between the working and counter electrodes to maintain a “desired voltage” between the working electrode and the reference electrode. The voltage between the reference electrode and the working electrode can be varied as a function of time in a programmed manner (for example, suitable results have been obtained using a linear change rate of 20 mV/s). The voltage window is determined by progressively increasing the desired voltage (in both the positive and negative directions) until there is a precipitous increase in the current required to drive the working and counter electrodes to maintain the desired voltage. The sharp rise in current at the end voltages generally indicates the breakdown voltage of the electrolyte, meaning that the salt or the solvent is undergoing a reduction reaction at the negative end voltage or an oxidation reaction at the positive end voltage. Such reactions could include gas evolution or simple oxidation/reduction reactions. The voltage difference between these two end voltages at which the current reaches a predetermined value, for example 100 mA/cm2, is called the electrochemical window or “voltage window.” As used herein, the term “electrochemical window” or “voltage window” refers to the voltage range which the electrolyte can tolerate without substantially reacting (i.e., undergoing reduction or oxidation). Although the voltage window tends to be relatively constant for a wide range of salt concentrations, the conductivity is maximum at the highest concentration. Therefore, relatively high concentrations of salts, for example, near the saturation point, are generally preferred from a performance standpoint. However, one may also take into consideration the cost of the salt in arriving at the most preferred optimum concentration.

The concentration of the salt in the solvent can be tailored to the application's particular needs. The preferred concentration of the electrolyte salt for the supercapacitor application is one at which the conductivity and the electrochemical window are maximum. Since the voltage window is generally constant for the various concentrations, optimization will typically be a function of optimizing conductivity. Furthermore, since the high surface area activated carbon electrodes are standard for non-aqueous systems, the power output capability depends mainly on the electrolyte conductivity. Higher electrolyte conductivity leads to lower internal voltage drop in the capacitor. Generally, increasing the concentration of the salt in the solvent will improve the electrolyte's conductivity which, in turn, improves its performance as an electrolyte. Accordingly, if the objective is to maximize conductivity, it is preferable to saturate the electrolyte composition with salt. However, if a particular conductivity can be met using a lower concentration of salt, cost considerations would dictate using sub-saturation levels of salt. In a TEABF4/PC electrolyte, suitable results have been obtained with a concentration of salt from about 0.5 to about 1.2 mol/l.

Applicants have discovered that a solvent having a relatively low viscosity is preferred to enhance mobility of the ions dissolved in it, especially at lower temperatures. To that end, according to the present invention, the solvent is augmented with additives designed to reduce its viscosity without diminishing significantly its electrical properties. These additives are referred to herein as “liquid viscosity reducing agents”.

A liquid viscosity reducing agent should satisfy several criteria to improve the conductivity of the electrolyte while not affecting the supercapacitor performance in any deleterious way. First, they should have a significantly lower viscosity than the nonaqueous solvent. Second, they should be electrochemically stable throughout the voltage window of the electrolyte. Third, they should have a lower freezing point than the nonaqueous solvent. Fourth, the liquid viscosity reducing agent should act as a solvent for the salt to some extent. Although the liquid viscosity reducing agent need not be as good a solvent as the nonaqueous solvent of the electrolyte, some solvent properties are desirable. Finally, they should have a density lower than that of the nonaqueous solvent. Lower density tends to be helpful to improve the power and energy density capabilities of the supercapacitors. More preferred liquid viscosity reducing agents have two or more of these criteria.

In a preferred embodiment, the liquid viscosity reducing agent has a viscosity which is less than half that of the nonaqueous solvent, and, more preferably, less than one quarter of that of the nonaqueous solvent. Preferably, the liquid viscosity reducing agent has a viscosity at room temperature of no greater than about 1.0 cP, and, more preferably, no greater than about 0.6 cP, and, even more preferably, no greater than about 0.5 cP. In other terms, the viscosity reducing agent should reduce the viscosity of the solvent at room temperature by about 10%, more preferably by about 20%, and even more preferably by about 25%.

In addition to having low viscosity, the liquid viscosity reducing agent should be stable throughout the voltage window of the electrolyte. For example, an electrolyte of PyHBF4 in PC at a concentration of 1.02 mol/l has a voltage window of 4 volts, an electrolyte of PyHBF4 in AN at a concentration of 0.59 mol/l solution has a voltage window of 3.5 V, and an electrolyte of PyHBF4 in GBL at a concentration of 1.62 mol/l solution has a voltage window of 4 volts. The liquid viscosity reducing agent used in such systems should be stable through a similar range. In a preferred embodiment, the liquid viscosity reducing agent is stable through the voltage window of at least about 2.5 V, and more preferably at least about 3 V, and still more preferably at least about 3.5V.

The liquid viscosity reducing agent should have a freezing point less than that of the non-aqueous solvent. In a preferred embodiment, the liquid viscosity reducing agent has a freezing point of less than 0° C. and, even more preferably, less than −10° C.

The liquid viscosity reducing agent should be somewhat of a solvent for the salt. Otherwise, its displacement of the non-aqueous solvent in the electrolyte will unmitigatingly diminish the amount of salt that can be dissolved in the electrolyte. In a preferred embodiment, the liquid viscosity reducing agent can dissolve at least about 0.01 mol/l of salt, and, more preferably, 0.03 mol/l.

The liquid viscosity reducing agent should have a density less than that of the nonaqueous solvent. In a preferred embodiment, the liquid viscosity reducing agent has a specific gravity of less than 1.

It has been found that ketones meet the criteria above. In particular, C3 to C10 ketones have been identified as suitable liquid viscosity reducing agents. More preferably, the liquid viscosity reducing agent is a C4 to C8 ketone. Still, more preferably, the ketone is a pentanone. In the most preferred embodiment, the ketone is 2-pentanone.

It has been found also that 2-pentanone not only meets the criteria above, but also provides acceptable performance even when used in an impure state. As used herein, the term “impure” refers to a purity less than 99.5%. It has been found that commercially-available 2-pentanone is impure and contains a significant concentration of MIBK. For example, gas chromatographic analysis shows that the major contaminant present in commercial grade 2-pentanone is MIBK at a concentration of 6-7% volume. This concentration can often reach 15% by volume and even higher. The presence of MIBK as an impurity in 2-pentanone has been found, quite unexpectantly, to have no significant detrimental effect on the performance of the electrolyte. Indeed, the MIBK impurity can be present in the viscosity reducing agent in concentrations up to and greater than about 45% by volume and higher without significantly diminishing the performance of the electrolyte. Even when the 2-pentanone is replaced with MIBK in PC/2-pentanone based electrolytes, the performance is close to that of PC/2-pentanone based electrolytes. Preferably, MIBK is present in the viscosity reducing agent in an amount from about 1 to about 45% by volume, more preferably from about 1 to about 15% by volume, and even more preferably from about 5 to about 10% by volume. Therefore, commercially-available impure 2-pentanone can be used without any further purification to eliminate MIBK as an additive in traditional electrolyte systems.

Generally, the concentration of the liquid viscosity reducing agent should be as high as possible while maintaining certain electrical performance standards. There are several reasons for this preference. First, increasing the concentration of the liquid viscosity reducing agent will lower the viscosity of the electrolyte. The lower viscosity will tend to improve the performance of the electrolyte not only at lower temperatures, but also through the entire thermal operating range. Second, due to the increased conductivity imparted by the liquid viscosity reducing agent, less salt can be used in the electrolyte to achieve the same performance. Since salt tends to be the most expensive component of the electrolyte, a significant cost reduction can be realized. Third, the liquid viscosity reducing agent also tends to be inexpensive relative to the solvent. Therefore, to the extent it can be used to displace solvent in the electrolyte without deleterious effects to the electrolyte, it will lower costs.

It has been found that the concentration of the liquid viscosity reducing agent will likely be limited by its ability to act as a solvent for the salt. Specifically, it has been found that ketones are not particularly good solvents for salts. For example, pure 2-pentanone has the ability to dissolve TEABF4 to a maximum concentration of 0.035 mol/l. Consequently, as the concentration of the liquid viscosity reducing agent increases in the electrolyte the ability of the electrolyte to maintain the salt in solution will decrease. As mentioned above, higher concentrations of salts generally result in higher conductivity, and, thus, conversely, lower concentrations of salts generally result in lower conductivity. For example, at the relatively low concentration of TEABF4 in pure 2-pentanone of 0.035 mol/l, the conductivity was only 0.404 mS/cm at room temperature. This is much lower than that of TEABF4 in PC. Therefore, the concentration of the liquid viscosity reducing agent in the electrolyte will be based on the optimization of cost, conductivity enhancements due to reduced viscosity, and conductivity determinants due to the reduced concentration of salt. One skilled in the art can readily perform this optimization in light of this application.

In one preferred embodiment, the liquid viscosity reducing agent is added to the electrolyte at a concentration such that the conductivity is no less than about 9 mS/cm, and more preferably, no less than about 10 mS/cm. In another preferred embodiment, the liquid viscosity reducing agent is added to the electrolyte at a concentration such that the viscosity of the electrolyte is less than 2 cp at room temperature, and, more preferably, less than about 1.75 cp at room temperature.

The concentration of the liquid viscosity reducing agent is preferably up to about 50 vol. % of the electrolyte, more preferably, up to about 25 vol. % of the electrolyte, and, even more preferably, up to about 15 vol. % of the electrolyte.

In addition to the liquid viscosity reducing agent, it may be preferable to add gas viscosity reducing agents such as CO₂, NO₂, and N₂O, especially to improve the electrolyte's performance at lower temperatures.

The power output capability of the supercapacitor using this electrolyte and carbon electrodes depends on the working voltage and the maximum current output capability. The working voltage is determined by the voltage window discussed above. The maximum current output (at least in double layer type supercapacitors) is mainly controlled by the electrical conductivity of the electrolyte as measured above using any conductivity meter. It has been found that the liquid viscosity reducing agent of the present invention is stable across the voltage window of the electrolyte and improves its conductivity.

The excellent performance and the relatively low cost of an electrolyte with the liquid viscosity reducing agent of the present invention make it ideal for use in electrolyte systems in batteries and capacitors, including single cell and multi-cell capacitor devices, and other non-aqueous electrochemical capacitors, such as the Type III redox polymer system (Ren et al. in Electrochemical Capacitors, F. M. Delnick and M. Tomkiewicy, Editors, PV95-29, p.15, The Electrochemical Society Proceedings Services, Pennington, N.J. (1996); Arbizzani et al., Adv. Mater. 8: 331, 1996) since the high concentration and increased conductivity obtainable for these electrolytes is possible for other non-aqueous systems.

The examples below are provided to illustrate the invention and should not be construed as limiting the invention to the particular embodiments disclosed therein.

### EXAMPLES

### Example 1

This example shows the use of a liquid viscosity reducing agent with PC-based electrolytes. The specific salts in these electrolytes were TEABF4 and PyBF4.

The electrolyte is formed by mixing PC with the respective salts. Specifically, high purity propylene carbonate solvent (Honeywell's Digirena grade or equivalent) and high purity salts of TEABF4 and PyBF4, in their sealed original containers, are transferred into a glove box. The moisture level and the oxygen level in the glove box are maintained below 1 or 2 ppm. This is the preferred level, however, below 10 ppm in both cases may be adequate. A known quantity of the high purity propylene carbonate solvent is transferred to a glass container with a cap or lid. A known amount of the particular salt is added to the container and mixed until all of the added quantity of the solid salt is dissolved. To facilitate the solubility, a magnetic stirrer bar is placed inside the solution and stirred well by placing it on a magnetic stirrer equipment. Once all the previously added salt is dissolved, another small known quantity of the salt is added and the procedure is repeated until trace amounts of undissolved salt can be seen. The amount of the salt and the solvent are used to calculate the solubility of the salt in propylene carbonate. Other concentrations of the solution which are less than saturated concentration are prepared by dissolving required amount of the salt in required amount of the solvent. It can also be prepared by diluting the saturated solution with the required amount of the solvent.

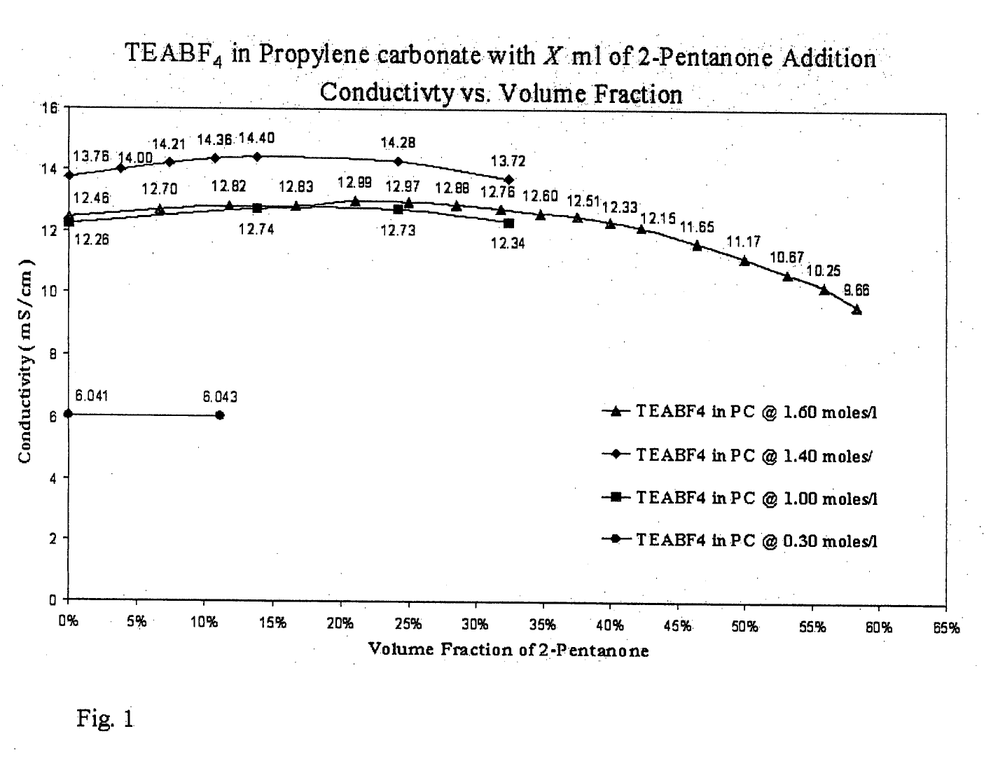

FIG. 1 shows the conductivity of the PC/TEABF4 electrolyte at 1.60, 1.40, 1.00, and 0.30 mol/l concentrations of TEABF4 with varying concentrations of the liquid viscosity reducing agent, 2-pentanone. The conductivity of each solution was measured using a VWR, NIST-Traceable conductivity meter. It is clear that the conductivity actually increases up to 20% by volume of the additive in all concentrations of the electrolyte. The conductivity remains higher than that of the pure electrolyte, up to 38% by volume of the additive in almost all concentrations of the TEABF4/PC electrolyte. Though the solution as a whole is getting diluted with the addition of pure 2-pentanone (without any dissolved TEABF4 in it), the conductivity is increasing or remains high. The mixed solvent electrolyte has acceptable conductivity of over 9 mS/cm levels almost up to 60% dilution of the electrolyte (1.6 mol/l concentration) with the additive. We believe it is primarily due to lowering of the viscosity of the electrolyte. It is well known that the freezing point decreases on addition of another substance. So we expect that the freezing point of the electrolyte with 2-pentanone additive to be lower than that of the pure electrolyte. Thus, it will have a better conductivity and capacitor performance at low temperatures.

The electrochemical stability is indicated by the cyclic voltammetry of the mixed electrolyte system. Approximately 15 ml of the experimental solution is transferred to an electrochemical microcell. The cell electrodes are then attached to the cell top. A 3 mm dia polished glassy carbon rod is used as a working electrode. (In our work, the carbon rod was covered on the cylindrical surface with a plastic sheath.) A silver wire is used as a reference electrode. The tip of the silver wire is placed as close to the working electrode as possible without touching it. A platinum foil is used as a counter electrode. The electrodes are attached to an EG&G Princeton Applied Research Corp M273A Potentiostat. The operation of the potentiostat is controlled by a desktop/personal computer using PARC M270 Research Electrochemical software. Cyclic voltametry experiments were performed using the above setup and electrodes. In this technique the initial voltage (voltage is also called potential) is measured. This is known as rest potential or open circuit potential. The current is substantially zero at this time. Then the voltage between the working electrode and the reference electrode is continuously scanned between a positive voltage limit and a negative voltage limit by changing the voltage at a constant rate. The voltage changes from the rest potential to one voltage limit, then to the other voltage limit and finally ending at the rest potential where it started. The current that flows between the working electrode and the counter electrode in response to the above voltage change is measured. The voltage-current data is plotted in graphical form and is called a cyclic voltammogram. Generally, the point at which the electrolyte begins to react is readily apparent by a precipitous change in current through the electrolyte for a relatively small change in voltage. Generally presence of a current peak on the top half or the bottom half of the graph indicates respectively an electrochemical reduction or oxidation process taking place at the potential corresponding to the peak location. The absence of peaks in both positive and negative directions of the voltammetry indicate the electrolyte is stable between the extremes where the current is observed to increase. The voltage difference between these end voltages at which the current starts to sharply increase is normally called the electrochemical window of the electrolyte. The increase in current at the end potentials is due to the breakdown of salt and/or solvent.

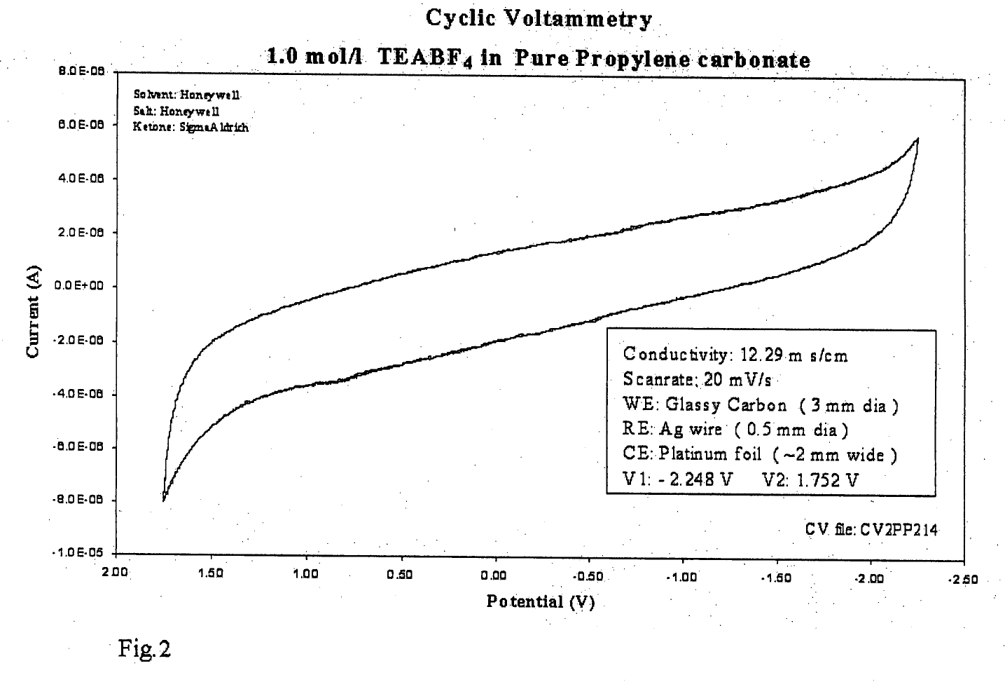

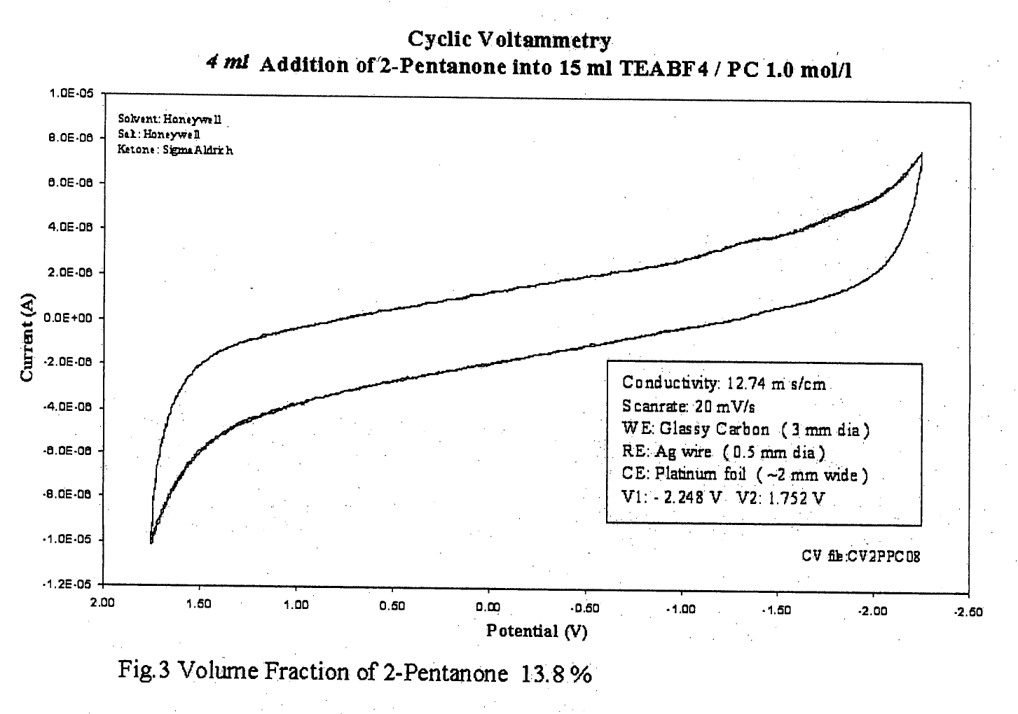

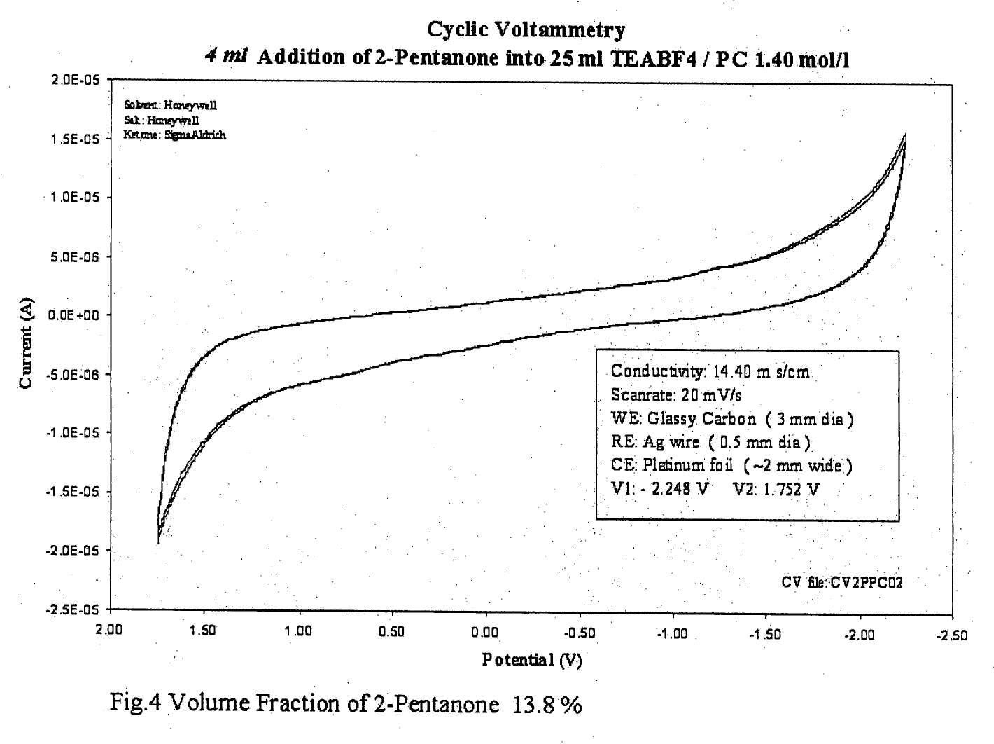

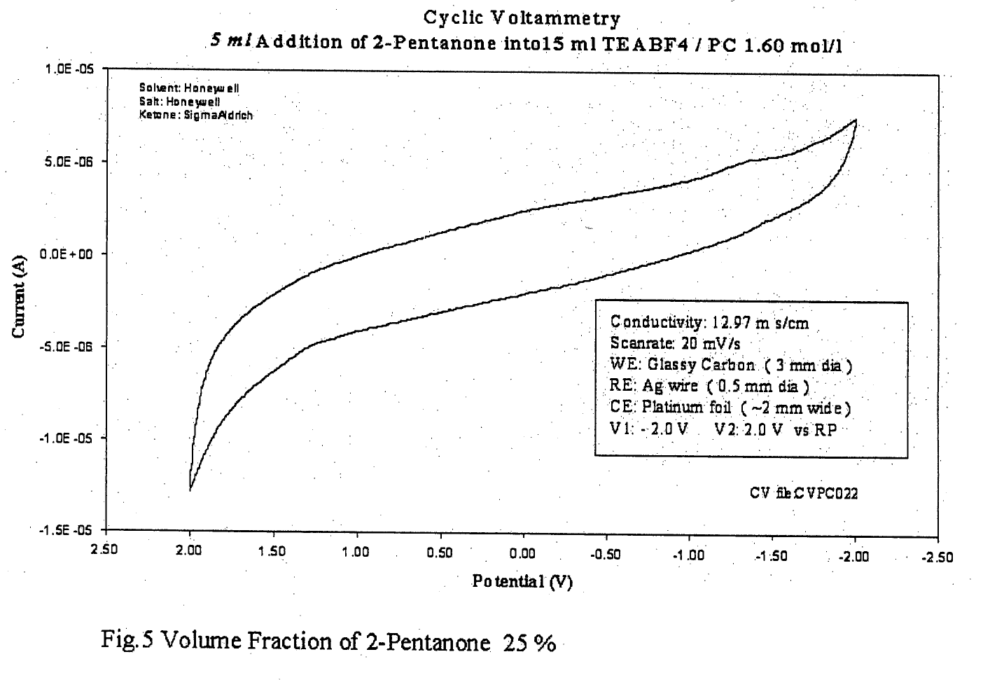

FIGS. 3, 4 and 5 show the cyclic voltammetry performed in the mixed electrolyte systems at the initial pure electrolyte concentration levels of 1, 1.4 and 1.6 mol/l. The corresponding volume fractions of 2-pentanone in the electrolyte are shown in the figures. Similarity of the cyclic voltammograms of the pure electrolyte (FIG. 2) and those in FIG. 3-5, coupled with absence of any peaks in the figures, clearly show that the mixed electrolyte is electrochemically stable and usable in supercapacitors.

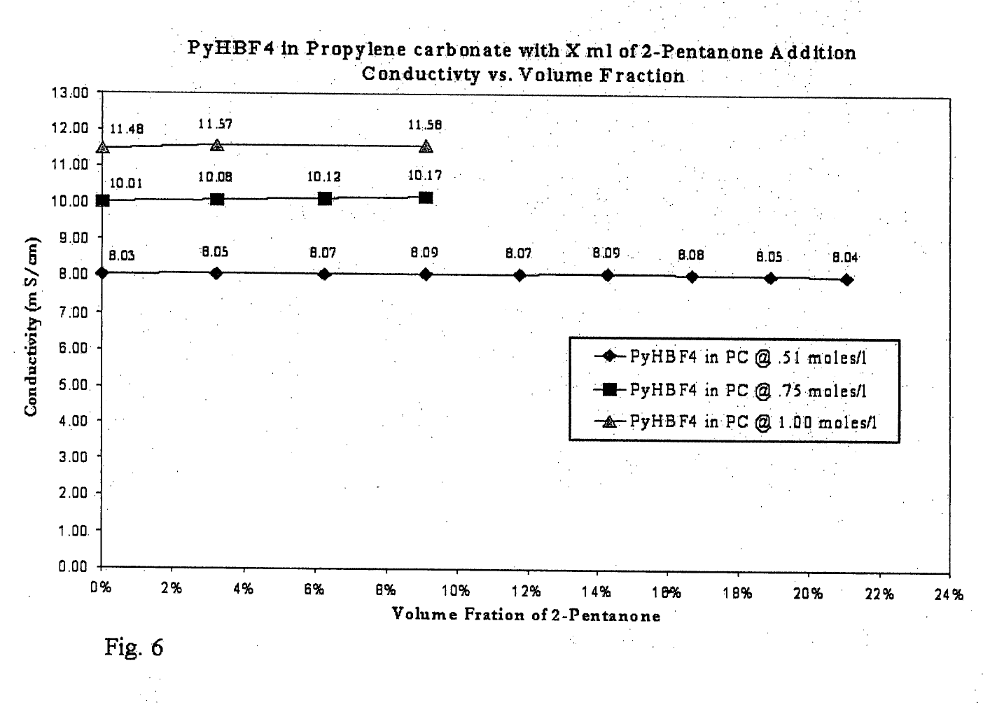

Similar studies with pyridinium tetrafluoroborate (PyHBF4) indicate that, in this electrolyte too, addition of 2-pentanone leads to better performance and same advantages. Specifically, the conductivity behavior of the solutions of PyHBF4/PC of different concentrations on addition of 2-pentanone is shown in FIG. 6. As with the TEABF4/PC electrolyte, the conductivity increases, albeit slightly, at least up to 10% addition of 2-pentanone in all three concentrations of the original pure electrolyte, i.e., 0.51, 0.75 and 1.00 mol/l. This suggests that 2-pentanone may be added to any PC based electrolyte whatever be the salt to improve performance and reduce cost. In fact, in general it indicates that a lower viscosity solvent may be added to a higher viscosity solvent based electrolyte to obtain better performance. The lower viscosity solvent, however, should have electrochemical stability, and possibly other desirable properties of a high performance solvent.

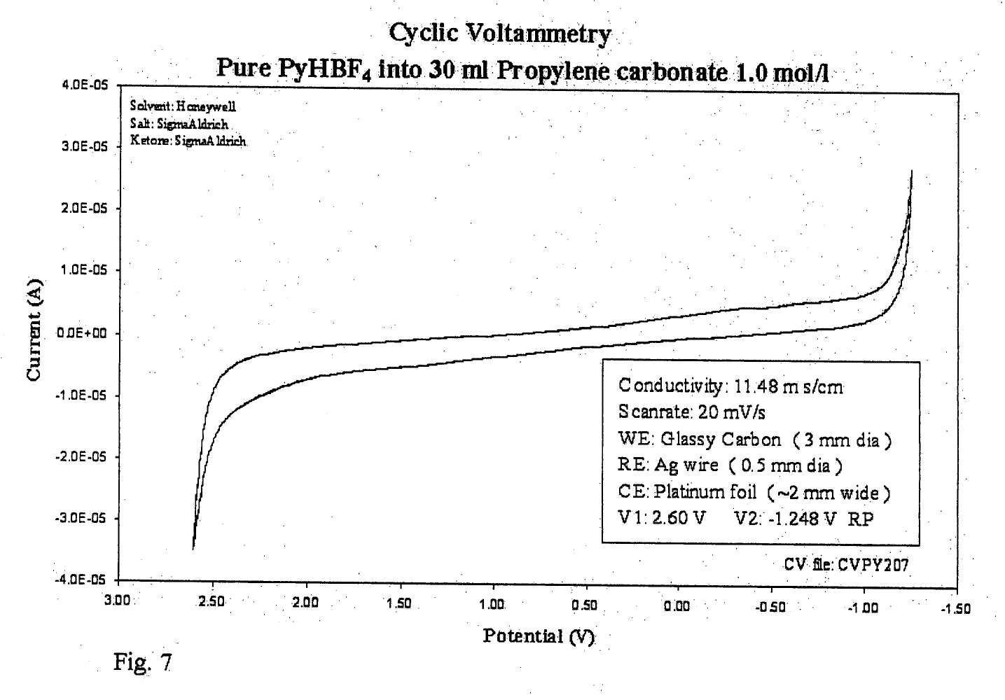

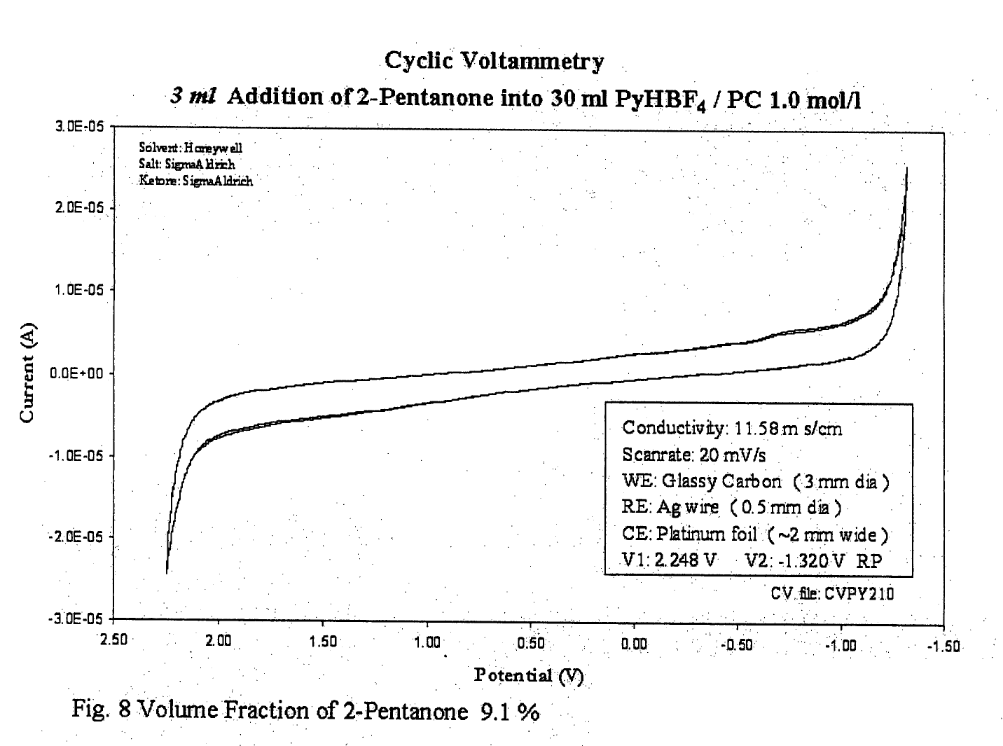

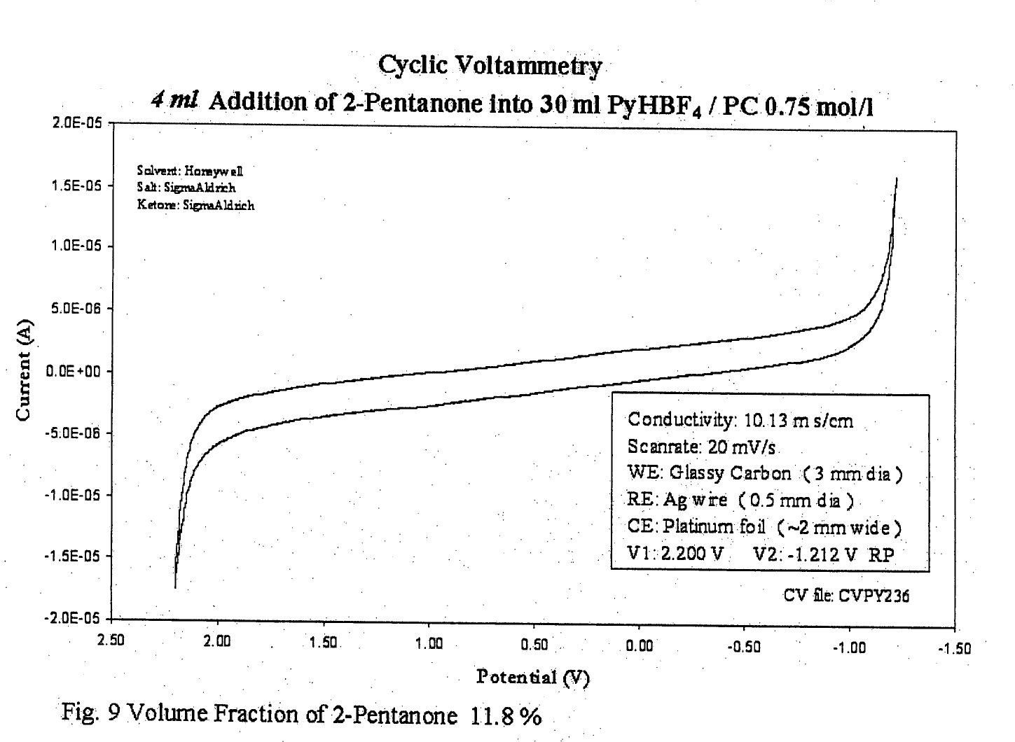

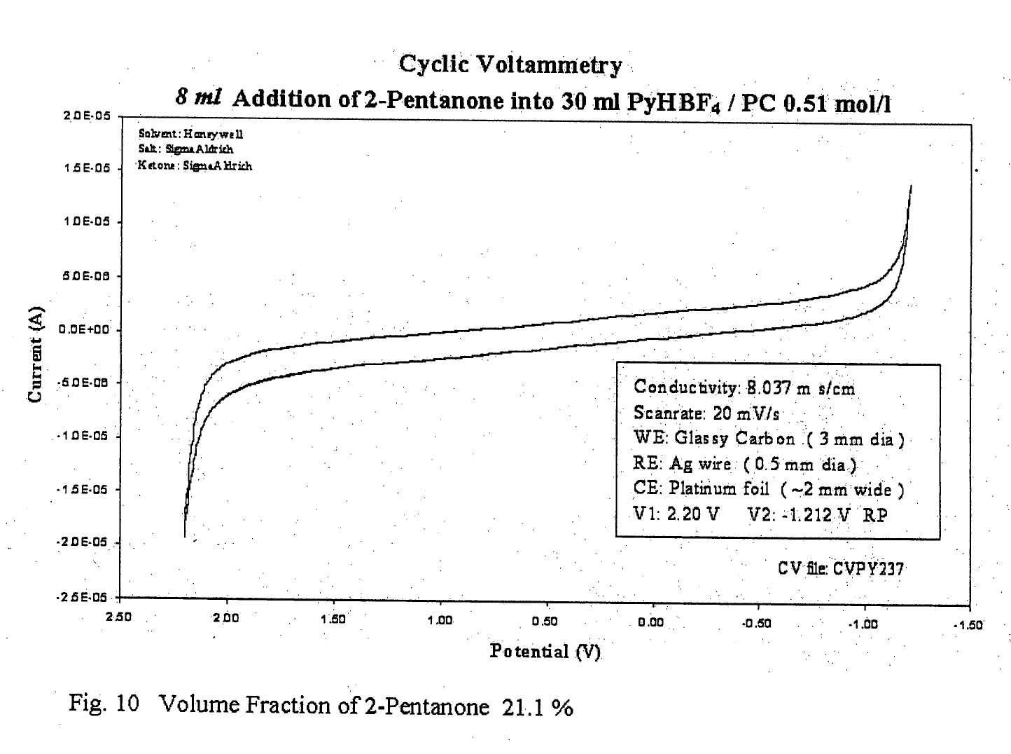

The electrochemical stability of PyHBF4/PC electrolyte in pure form and those with the addition of 2-pentanone are shown in FIG. 7-10. FIGS. 8-10 show the stability of different original concentrations of the electrolyte, i.e., 0.51, 0.75 and 1.00 mol/l with the addition of 2-pentanone. They are not at all affected electrochemically by the addition of 2-pentanone as evident from the similarity of all these figures. Thus, the figures indicate the suitability of this mixed solvent electrolyte for the supercapacitor application.

### Example 2

This example shows the use of a liquid viscosity reducing agent with GBL-based electrolytes. The specific salts in these electrolytes were TEABF4 and PyBF4.

The electrolytes of this example were prepared in similar fashion as discussed above with respect to the PC-based electrolytes. Obviously though, in this case, high purity gamma butyrolactone solvent (Honeywell's Digirena grade or equivalent) was used instead of PC.

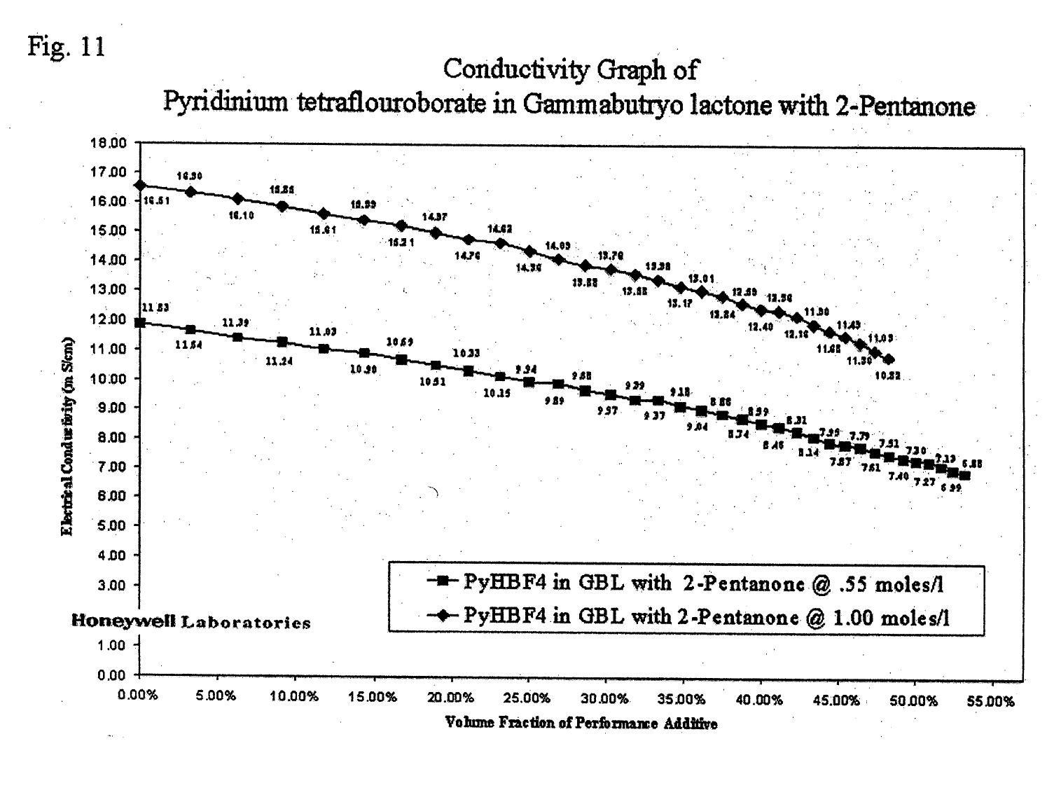

FIG. 11 shows the conductivity of PyHBF4/GBL electrolytes at 1.00, and 0.55 mol/l salt concentrations with varying concentrations of the liquid viscosity reducing agent, 2-pentanone. The conductivity of 1 mol/l solution remains higher than the generally required level of 10 mS/cm through the entire region of dilution shown in FIG. 11. The conductivity of the lower concentration electrolyte of 0.55 mol/l remains higher than the required level of 10 mS/cm up to almost 25% of 2-pentanone by volume. Thus, one can use 1 molar PyHBF4/GBL electrolyte diluted up to 50% by volume with 2-pentanone in capacitors or any other electrochemical device. Similarly in the case of 0.55 molar solutions, one can dilute up to 25% by volume with 2-pentanone and use in electrochemical devices. In devices where high conductivity is not critical one can dilute even more with this solvent. We believe it is primarily due to lowering of the viscosity of the electrolyte. It is well known that freezing point decreases on addition of another substance. So we expect that the freezing point of the electrolyte with 2-pentanone additive to be lower than that of the pure electrolyte. Thus, it will have a better conductivity and capacitor performance at low temperatures.

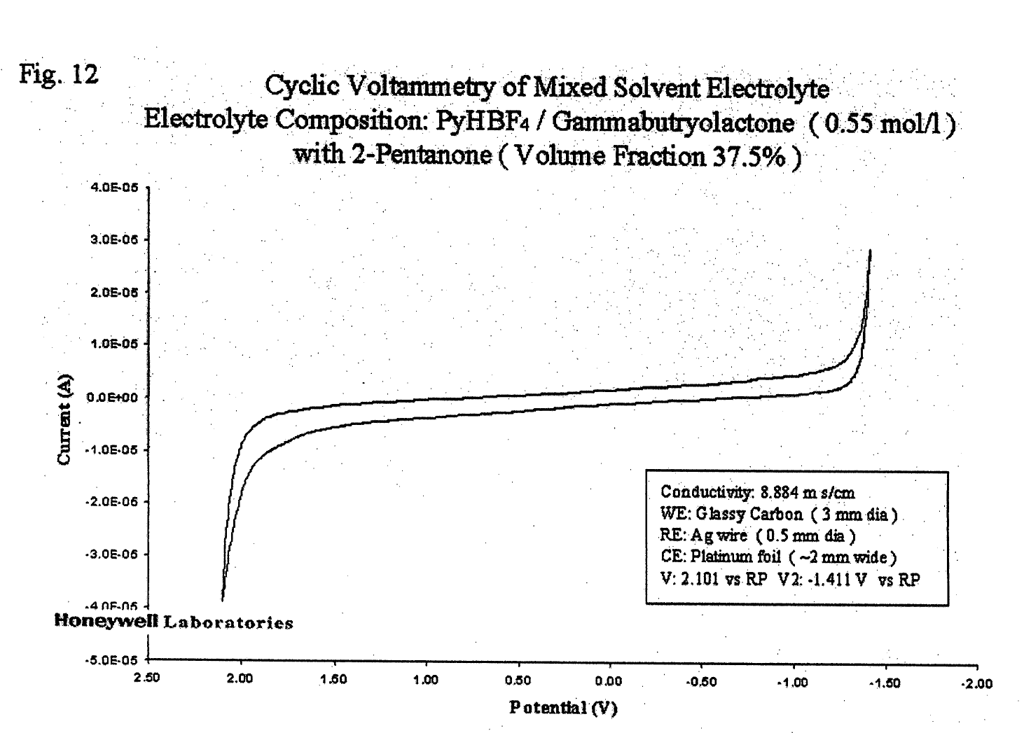

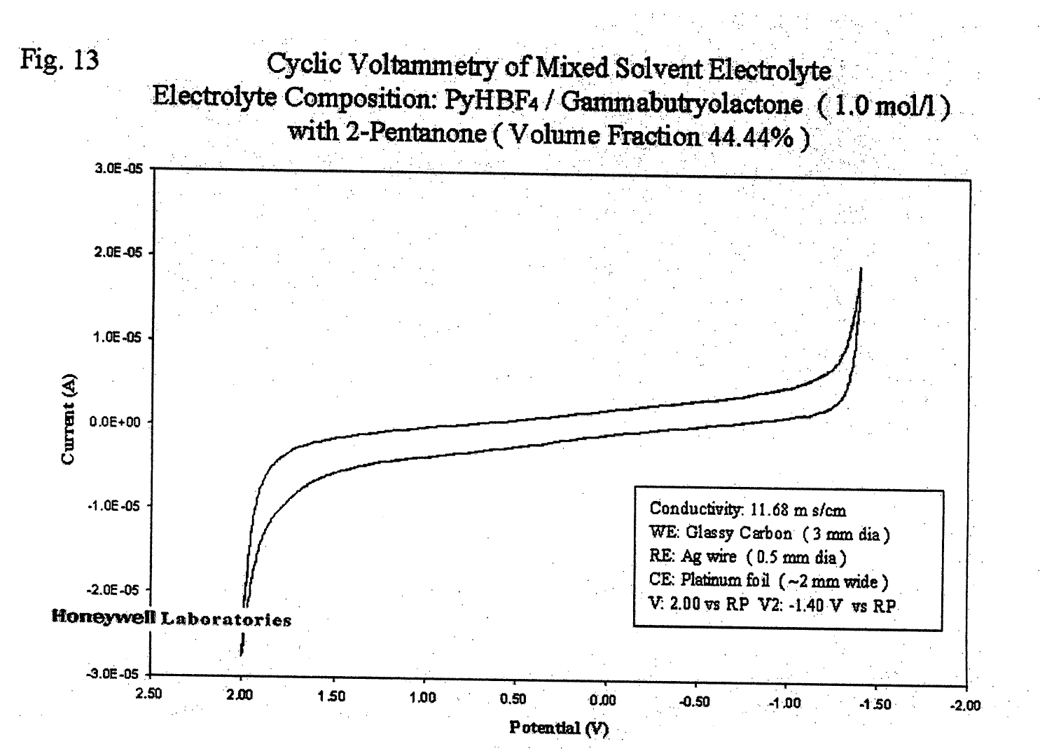

The electrochemical stability is indicated by the cyclic voltammetry of the mixed solvent electrolyte system. FIGS. 12 and 13 show the cyclic voltammetry performed in PyHBF4/GBL electrolytes with initial concentrations of 0.55 and 1 mol/l with 2-pentanone additive of 37.5% and 44.4% respectively. Thus, the figures indicate the suitability of this mixed solvent electrolyte for the supercapacitor application.

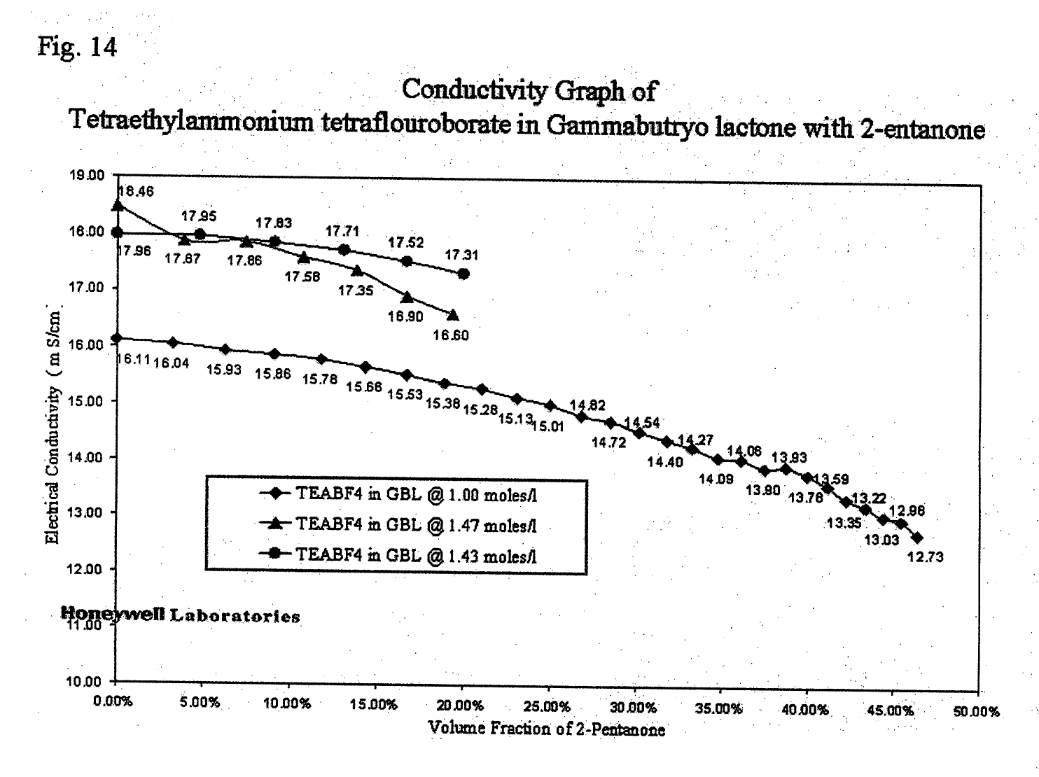

FIG. 14 shows the conductivity data of TEABF4/GBL electrolytes at salt concentrations of 1.00, 1.43 and 1.47 moles/liter with varying concentrations of the liquid viscosity reducing agent, 2-pentanone. The last solution is very close to saturation limit. As seen in the figure, the conductivity is changed only slightly from that of the pure electrolyte. This indicates that the TEABF4/GBL electrolyte diluted with 2-pentanone is also suitable for the electrochemical devices including supercapacitors. The invention disclosed here is similar to that observed in propylene carbonate-based electrolytes with the same salts. The commonality between them makes us to infer that any second solvent with lower viscosity will improve or at least will not substantially lower the conductivity. This behavior of the conductivity of the mixed solvent system combined with lowering of viscosity is expected to improve the low temperature performance of the electrolyte.

### Example 3

This example illustrates that the addition of 2-pentanone containing an impurity of methyl isobutyl ketone (MIBK) to an electrolyte of tetraethyl ammonium tetrafluoroborate (TEABF4)/propylene carbonate (PC) does not diminish the effectiveness of the electrolyte. The study includes the standard voltammetry at 20 mV/s scan rate and conductivity measurements, a slow scan voltammetry at 1 mV/s and chronoamperometric (CA) studies. The slow scan was used to increase the “residence time” at each potential and hence enhance any hidden minor electrochemical reaction. The CA experiments at either end of a 3 V window, the rated voltage for the non-aqueous capacitors, are performed to determine if extended time at the fully charged potentials of the capacitor degrades the electrolyte. The electrolytes were again analyzed at the end of the electrochemical tests using GC to determine if any new products have formed. It was found that the presence of MIBK does not affect the performance of the electrolyte, thereby indicating that the commercial 2-pentanone can be used as is, as an additive to the propylene carbonate (PC) (or similar solvents such as gamma butyrolactone (GBL)) based electrolytes using TEABF4 as the salt (or similar salts such as methyl triethyl ammonium tetrafluoroborate (MTEABF4). Therefore, anyone skilled in the art can appreciate that this invention of using commercial 2-pentanone as a second additive solvent equally holds good for any electrolyte using TEABF4 or MTEABF4 or a mixture of these salts in any ratio in a single solvent or a mixture of the solvents like PC, GBL in any ratio.

This experiment is now considered in detail. Testing was performed on three different electrolyte compositions: the first electrolyte was a 1 mol/l TEABF4/PC solution using Honeywell Digirena salt and solvent; the second electrolyte was a 0.85 mol/l TEABF4/PC-2 pentanone solution; and the third electrolyte was a 0.85 mol/l TEABF4/PC-2 pentanone solution with 7% methyl isobutyl ketone (MIBK). The 2-pentanone was from Sigma Aldrich (99.5% pure, 450 ppm water) and the high purity methyl isobutyl ketone (MIBK) was also from Sigma Aldrich. The lower concentration in the two solvent systems (0.85 mol/l versus 1 mol/liter) was chosen since its performance was comparable to the 1 mol first electrolyte. The concentration of MIBK was based on a gas chromatographic analysis which indicated that the major contaminant present in commercial grade 2-pentanone is (MIBK) at a concentration of 6-7% volume.

PC/2-pentanone solvents were mixed in 80/20 ratio. To this end, 9.226 grams of TEABF4 was taken in a 50 ml volumetric flask and the solvent mixture was added to dissolve the salt and made up to 50 ml mark. Solvent for the third electrolyte was made first by mixing 2-pentanone with 7% MIBK followed by mixing this combined solvent with PC in the ratio of 20/80 respectively. 9.226 grams of TEABF4 and this final solvent mixture were used to prepare the third electrolyte in a volumetric flask as mentioned above.

The electrochemical cell used a glassy carbon micro electrode as working electrode, a silver wire reference electrode and platinum foil counter electrode. After measuring the conductivity, a cyclic voltammetry (CV) test was performed at 20 mV/s scan rate followed by another CV test at 1 mV/s scan rate. The potentials for the chronoamperometry tests were chosen to be 1.5 V and −1.5 V based on the most linear three volts portion of the CV curves. The first CA test was performed at 1.5 V versus the silver reference electrode. The current was measured as a function of time for three hours. The two CV tests were repeated in the same order. This was followed by another chronoamperometry test at the negative end (−1.5 V versus silver electrode). Again the two CV tests were repeated. After the experiments were completed, the conductivity of the electrolytes was measured again to see if they changed.

For comparison another aliquot of the initial electrolytes in each category was also measured for its conductivity. Generally we ran three cycles in all electrolytes at the 20 mV/sec scan rate and recorded the first and the third cycles.

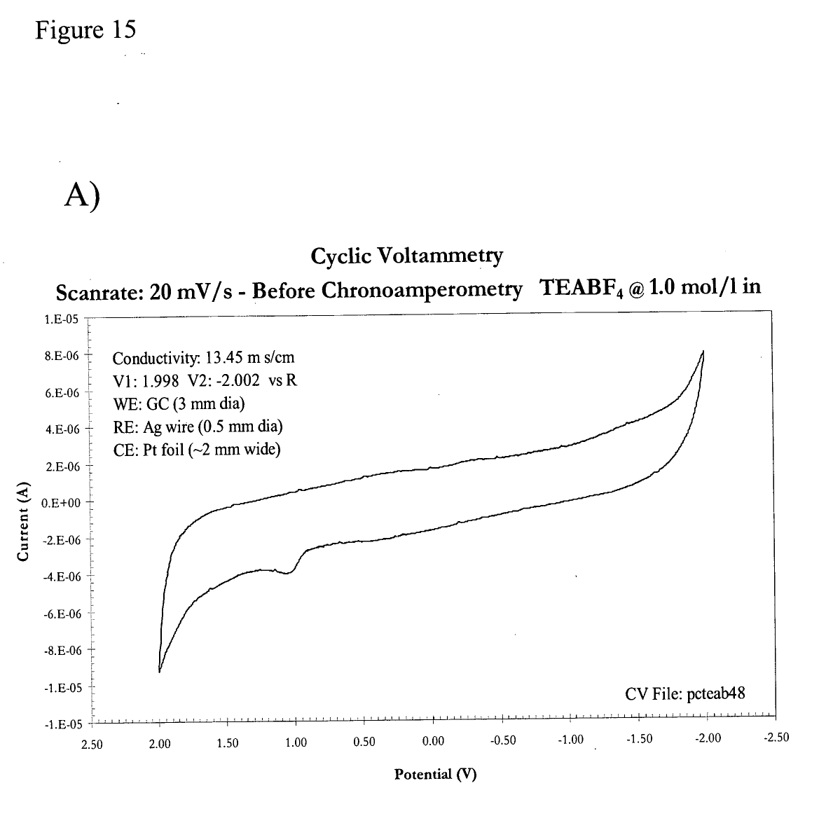

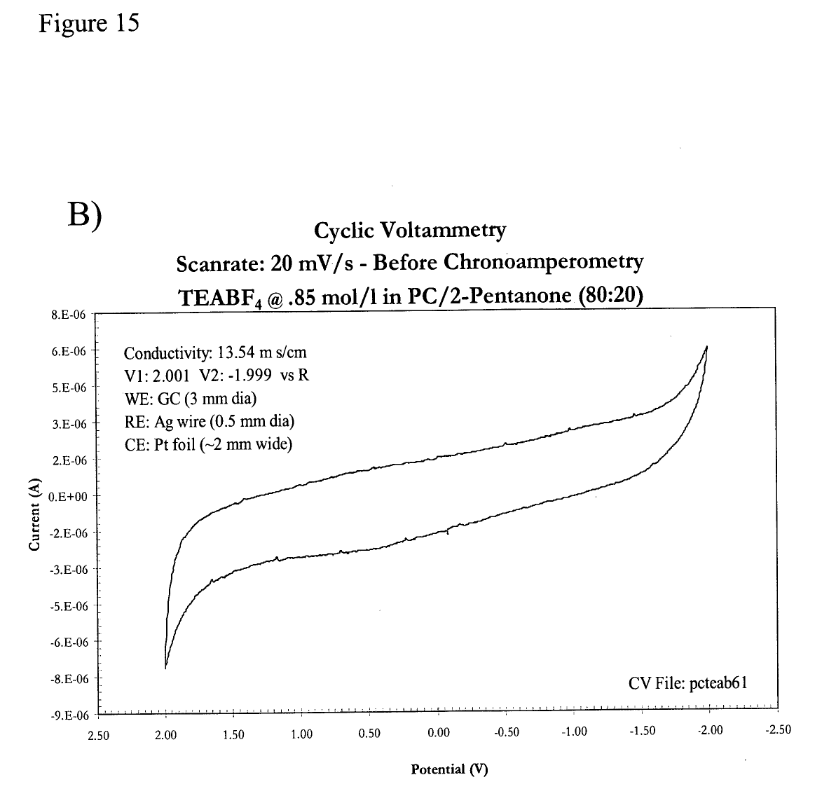

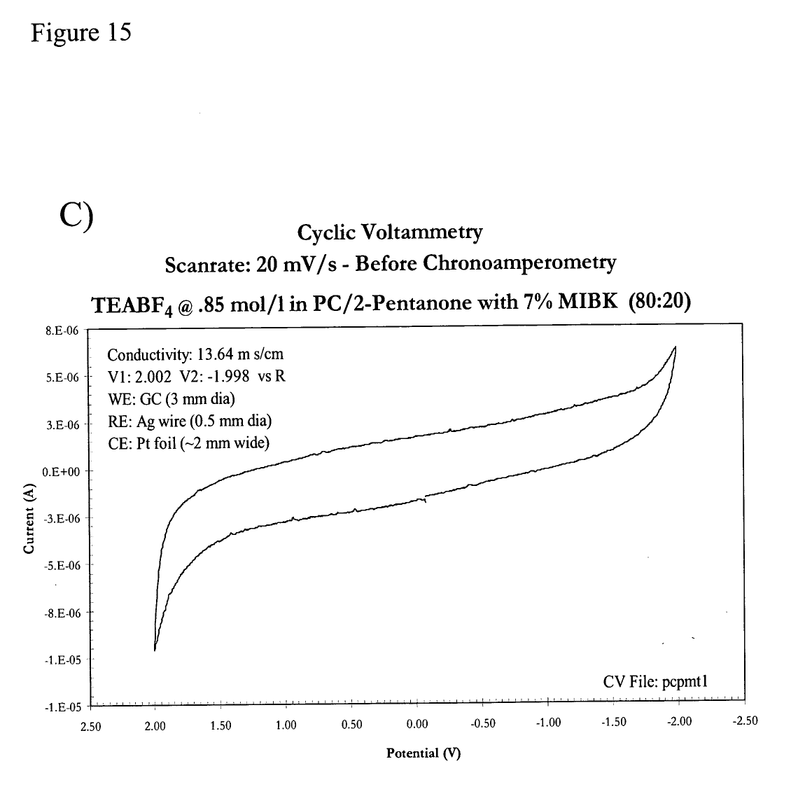

FIG. 15 shows current-voltage data for all three electrolytes at 20 mV/sec scan rate prior to any chronoamperometric or slow scan voltammetric experiments. There is no difference between the curves in these three electrolytes thereby indicating that 2-pentanone and MIBK do not affect the performance of the electrolyte. Specifically, FIG. 15A shows the scans in cyclic voltammetry of the standard (1 molar TEABF4/PC) electrolyte. In all cases, we did not see substantial difference between the different cycles of the same electrolyte. There are no unknown redox peaks in any of them. The pure electrolyte shows an oxidation peak at around 1 V, which is typical of the oxygen contamination in the standard electrolyte (FIG. 15A). FIGS. 15B&C show the curves in TEABF4/PC/2-pentanone and TEABF4/PC/2-pentanone/MIBK electrolytes are a little bulging from 0 V to 1 V. This appears to be due also to the water and oxygen contamination. On multiple cycles this bulging disappears, probably when the water/oxygen was depleted due to electrolysis. Since the amount of water present is low (in ppm level) we were not able to see any gas bubbles on the electrode surface. In the standard electrolyte also, there is a very slight bulging near 0 to 0.7 V.

After the 20 mV/s scan rate experiments, the cyclic voltammetry experiments were performed at 1 mV/s slow scan to increase the “residence time” at each potential to bring out any minor reaction. The behavior was very similar to the fast scan results and exhibited no difference between the curves recorded in all three electrolytes attributable to the presence of 2-pentanone or MIBK.

Chronoamperometric (CA) tests were done at 1.5 V versus silver electrode. The CA current data as a function of time at 1.5 V was recorded and compared with each other in all three electrolytes. The general behavior is same in all three electrolytes. The instantaneous current reached is approximately 4 E-06 A in all three cases. One can almost superimpose them on one another. This indicates that the charge build up rate is similar, even though the concentration of TEABF4 is lower in mixed solvents (0.85 molar in B & C compared 1 molar in A).

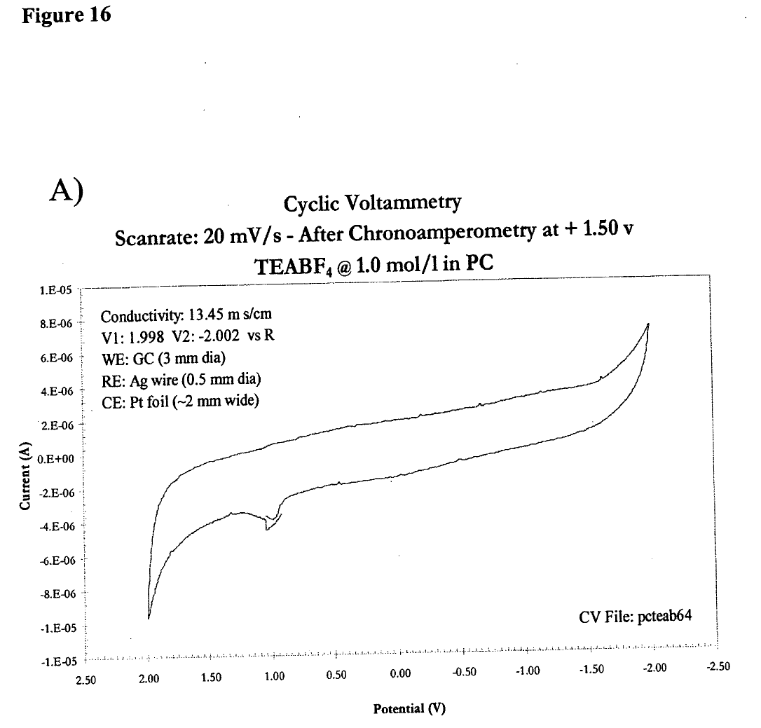

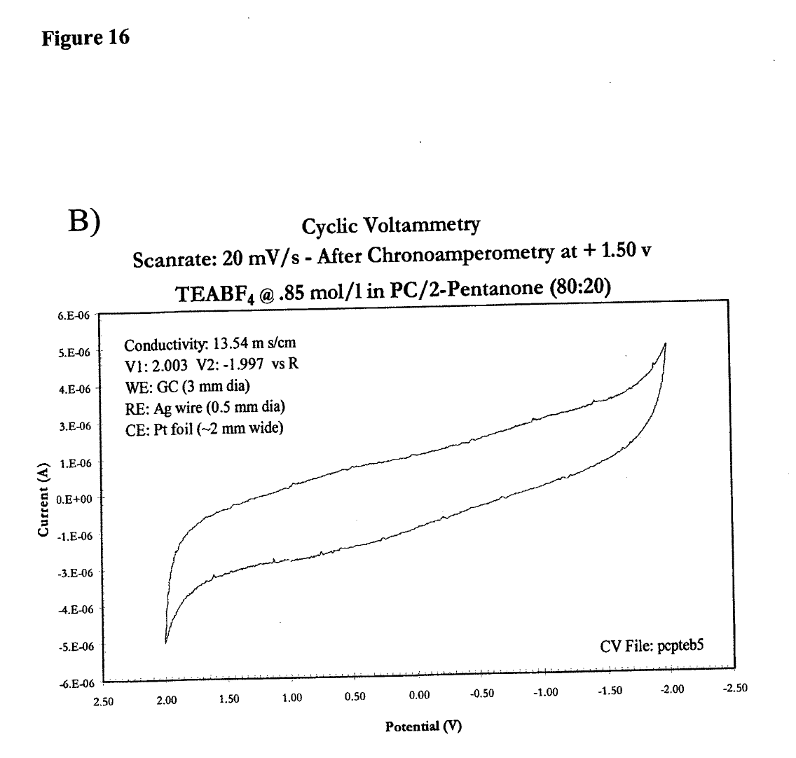

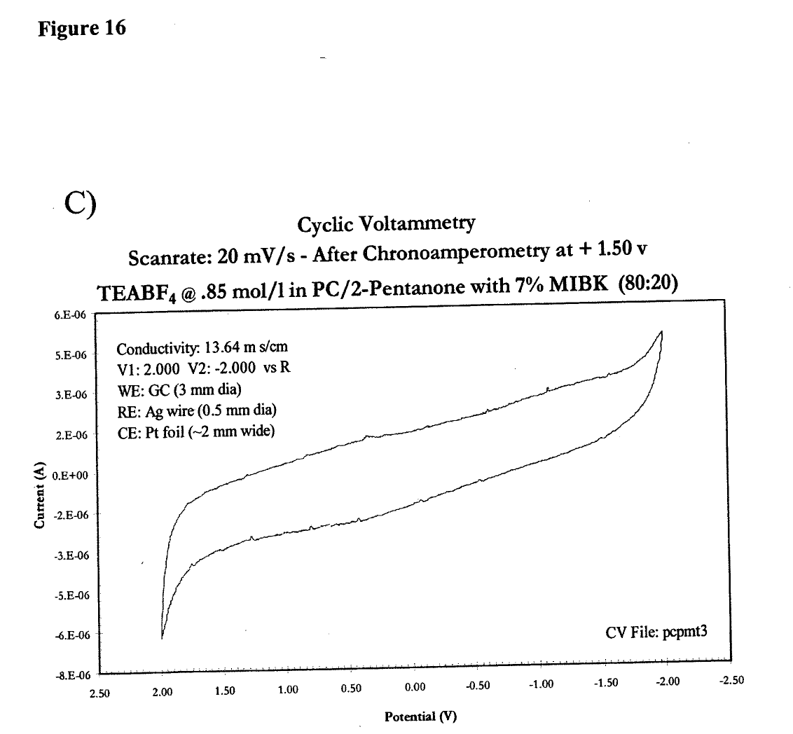

To determine if any new products are formed as a result of the chronoamperometric tests at 1.5 V versus silver electrode, new CV tests were conducted in all three electrolytes in fast (20 mV/sec) and slow scan (1 mV/sec) rates. The current-voltage data in the fast scan are shown in FIG. 16 for all three electrolytes. These are practically same as the ones shown in FIG. 15. There is no change introduced due to chronoamperometric studies. Pure electrolyte shows a shallow peak for oxygen and the mixed electrolytes exhibit broad bulging similar to the ones before undergoing chronoamperometry. The slow scan curves are very similar to each other also.

Similar to the positive end potential, the chronoamperometric tests were performed at the negative end, −1.5 V versus silver electrode. Practically, there is no difference in the current versus time data of all three cases indicating the solvent additives do not interfere electrochemically. The instantaneous current (2.5 E-06 A) and the final current at the end of 3 hours (around 3 E-07 A) are comparable to each other in all three cases. Again it is worth remembering that the concentration of TEABF4 is 0.85 molar in B & C (mixed solvents with & without MIBK) compared to 1 molar in A (pure electrolyte).

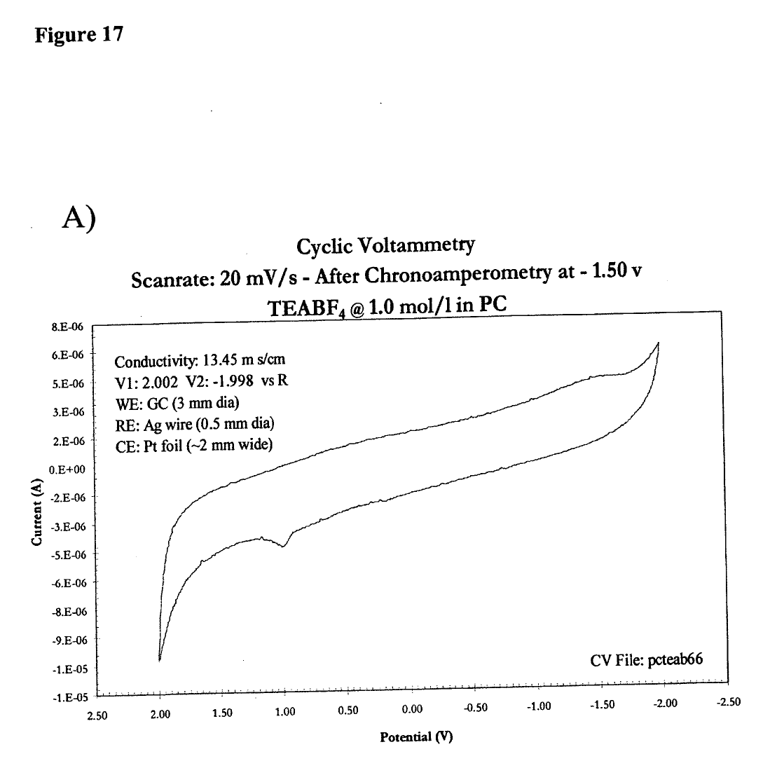

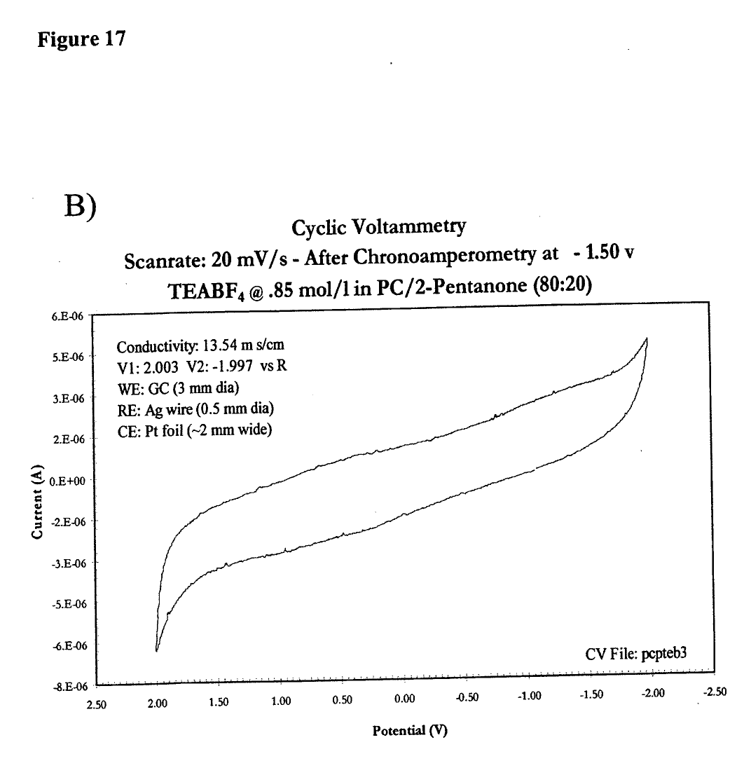

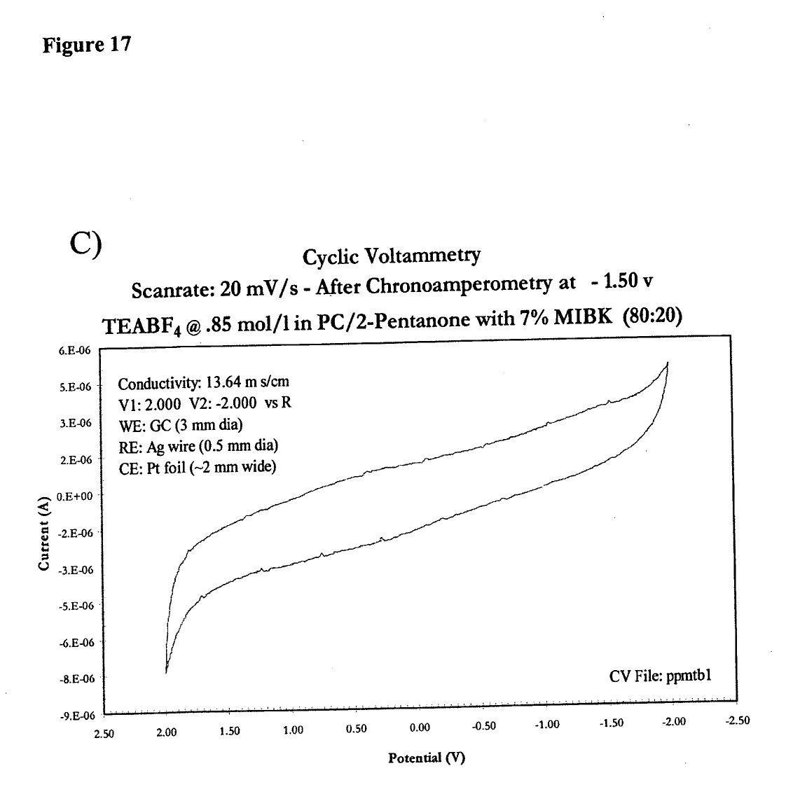

The fast and slow scan voltammetry data (FIG. 17) collected after the above chronoamperometry experiment at −1.5 V versus silver electrode are very similar to the ones shown in FIGS. 15 & 16 indicating that the chronoamperometric studies do not alter the electrochemical characteristics of the electrolytes. The minor difference is in FIG. 17A. In this case the pure electrolyte seems to have the shoulder at the negative end shifted a little bit towards the positive side. Slow scan curves are similar to each other.

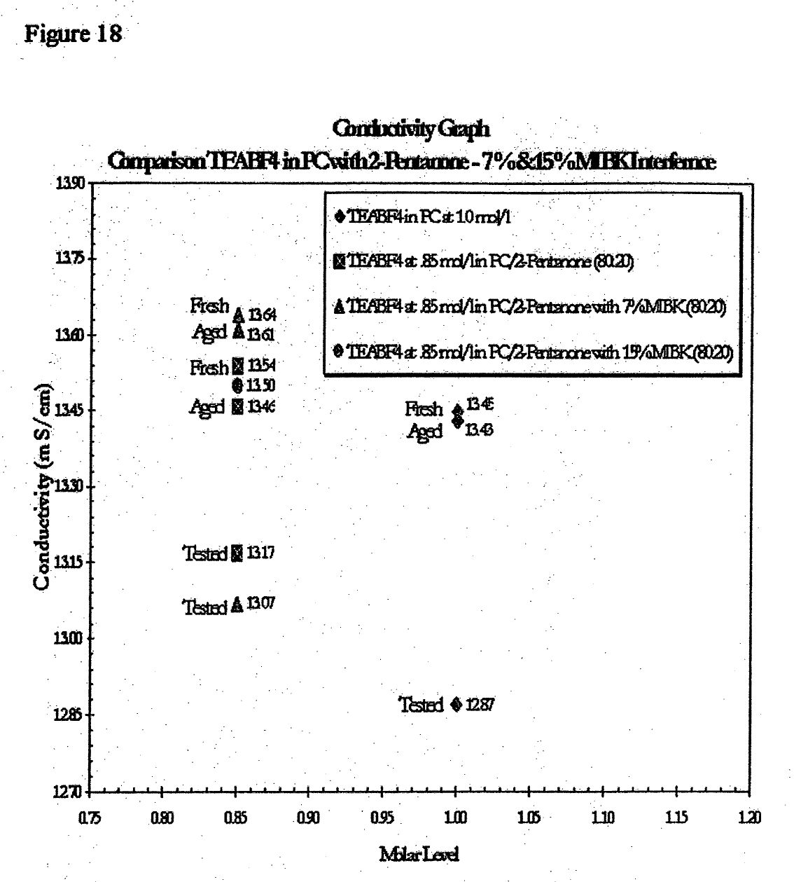

FIG. 18 shows the conductivity data measured at different times. The first conductivity measurement is made-as soon as the electrolyte is prepared. It is marked as “Fresh” in the figure. The second measurement was made on the experimental electrolytes after completing all electrochemical experiments. The third conductivity measurement was made at the same time as the second except that it used another portion of the electrolyte belonging to the same lot as the one used in all experiments. The second one is marked as “Tested” while the third is marked as “Aged”. When the electrolytes are fresh both mixed solvent electrolytes show slightly higher conductivity at 0.85 molar concentration than the pure 1 molar standard electrolyte. Aging does not affect the conductivity significantly in all three cases.

It is a bit surprising that the conductivity of tested electrolytes is lower than the fresh ones in all three corresponding cases. However, the presence of 2-pentanone or MIBK does not seem to affect the conductivity significantly due to aging or usage any more than the pure electrolyte suffers on its own.

Gas chromatographic analysis was done on all three electrolytes before and after all these tests. They do not show presence of any new compounds thereby indicating the additives, 2-pentanone and MIBK do not undergo any electrochemical reaction or degrading of the electrolyte.

In summary, we did not find any adverse effect on the PC based electrolyte due to the presence of MIBK. Chronoamperometric studies at 1.5 or −1.5 volts do not degrade the mixed electrolyte any more than the pure electrolyte itself. The conductivity seems to get slightly lower on usage in all cases. In short, there is no discernible difference between the different electrolytes indicating that the commercial 2-pentanone can be used in the two solvent system (PC/2-pentanone) with a lower concentration of the salt.

### Example 4

This example shows that MIBK, itself, can be used as a viscosity reducing agent. This particular example illustrates using the TEABF4/PC electrolyte with MIBK, although this concept is equally applicable to other electrolytes using salts such as methyl triethyl ammonium tetrafluoroborate or pyridinium tetrafluoroborate or other commonly used salts in PC or other commonly used solvents.

The TEABF4/PC based electrolytes were prepared in 1 and 0.75 molar concentrations with MIBK as the viscosity reducing agent, the proportion being PC/MIBK at 90/10 and 75/25 percent. For comparison purposes, a 1 molar pure TEABF4/PC electrolyte without MIBK was also prepared. The conductivity of all these electrolytes were measured as described previously. The values are listed in Table 1.

The conductivity of 1 molar solution of TEABF4/PC(80%)/MIBK(20%) is higher than that of the same concentration electrolyte without the viscosity reducing agent. The conductivity is even higher when the electrolyte has 10% MIBK in it. Even at 0.75 molar concentration of TEABF4, the conductivity values are only slightly lower than that of the 1 molar standard electrolyte without MIBK. Thus adding MIBK to the electrolyte provides higher conductivity and performance to the supercapacitors.

TABLE 1
PC/MIBK in REABF4

| | | | Conductivity |
|---|---|---|---|
| Concentration (mol/l) | PC Fraction | MIBK Fraction | (mS/cm) |
| 0.75 | 0.8 | 0.2 | 11.38 |
| 0.75 | 0.9 | 0.1 | 11.59 |
| 1 | 0.8 | 0.2 | 12.34 |
| 1 | 0.9 | 0.1 | 13.57 |
| 1 | 100 | 0 | 12.26 |

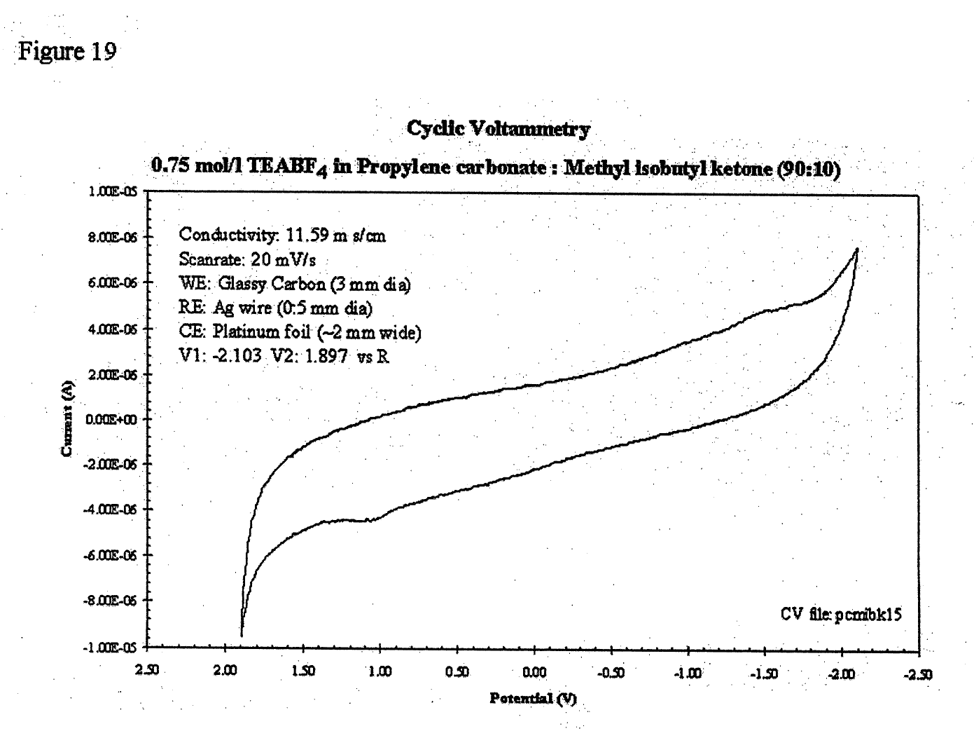

The stability of the PC/MIBK based electrolyte is demonstrated in FIG. 19 using the 0.75 molar TEABF4/PC(90%)/MIBK(10%) electrolyte. There are no oxidation or reduction peaks with an electrochemical stability window very similar to the pure TEABF4/PC electrolyte.

In summary MIBK can be used as a viscosity reducing agent enhancing the performance of the commonly used electrolytes using such salts as tetraethyl ammonium tetrafluoroborate, methyl triethyl ammonium tetrafluoroborate, pyridinium tetrafluoroborate and solvents like PC, GBL, valeronitrile, etc.

1. A nonaqueous electrolyte for an electrical storage device comprising a nonaqueous solvent, a salt dissolved in said nonaqueous solvent, and a liquid viscosity reducing agent in sufficient quantity to substantially reduce the viscosity of the electrolyte below the viscosity of the nonaqueous solvent.

2. The electrolyte of claim 1, wherein said liquid viscosity reducing agent has a viscosity that is less than half of that of said organic solvent.

3. The electrolyte of claim 2, wherein said liquid viscosity reducing agent has a viscosity that is less than about a quarter of that of said organic solvent.

4. The electrolyte of claim 1, wherein said liquid viscosity reducing agent has a viscosity that is less than about 0.6 cP at room temperature.

5. The electrolyte of claim 1, wherein said liquid viscosity reducing agent has a density less than that of said organic solvent.

6. The electrolyte of claim 1, wherein said liquid viscosity reducing agent has a specific gravity less than about 1.

7. The electrolyte of claim 1, wherein said liquid viscosity reducing agent is a C3 to C10 ketone.

8. The electrolyte of claim 7, wherein said liquid viscosity reducing agent is a C4 to C8 ketone.

9. The electrolyte of claim 8, wherein said liquid viscosity reducing agent is pentanone.

10. The electrolyte of claim 9, wherein said liquid viscosity reducing agent is 2-pentanone.

11. The electrolyte of claim 10, wherein said viscosity reducing agent comprises impure 2-pentanone.

12. The electrolyte of claim 11, wherein said viscosity reducing agent comprises 1-45% by volume of methyl isobutyl ketone (MIBK) impurity.

13. The electrolyte of claim 12, wherein said viscosity reducing agent comprises about 5-10% by volume of MIBK.

14. The electrolyte of claim 1, wherein said liquid viscosity reducing agent comprises at least 25 vol. % of said electrolyte.

15. The electrolyte of claim 1, wherein said liquid viscosity reducing agent comprises up to about 50 vol. % of said electrolyte.

16. The electrolyte of claim 13, wherein said electrolyte has a viscosity of less than 0.6 cP at room temperature.

17. The electrolyte of claim 16, wherein said electrolyte has a conductivity of greater than 10 mS/cm.

18. The electrolyte of claim 1, wherein said salt is a combination of an anion selected from perfluoro anions and perfluoro, organic sulfonates and a cation selected from tetraethyl ammonium or methyl triethyl ammonium or pyridinium.

19. The electrolyte of claim 18, wherein said salt is tetraethyl ammonium tetrafluoroborate or methyl triethyl ammonium tetrafluoroborate or pyridinium tetrafluoroborate.

20. The electrolyte of claim 18, wherein said organic solvent is selected from the group consisting of linear ethers, cyclic ethers, esters, carbonates, formates, lactones, nitrites, dinitriles, amides, sulfones and sulfolanes.

21. The electrolyte of claim 19, wherein said organic solvent is selected from the group consisting of PC and GBL.

22. The electrolyte of claim 1, wherein said salt is dissolved in said organic solvent at a concentration of greater than 0.5 mol/l.

23. The electrolyte of claim 22, wherein said salt is dissolved in said organic solvent a concentration of greater than 1 mol/l.

24. The electrolyte of claim 1, wherein said electrolyte has a voltage window of at least 3 volts.

25. The electrolyte of claim 24, wherein said electrolyte has a voltage window of at least 3.8 volts.

26. The electrolyte of claim 1, wherein said electrolyte comprises an additional salt.

27. The electrolyte of claim 26, wherein said additional salt is a tetraalkylammonium or tetraalkylphosphonium.

28. The electrolyte of claim 9, wherein said liquid viscosity reducing agent is methyl isobutyl ketone.

29. An electrical energy storage device comprising the electrolyte of claims 1.

30. The electrical energy storage device of claim 28, further comprising carbon-based electrodes.

31. A non-aqueous electrolyte for an electrical storage device comprising a non-aqueous solvent, a salt dissolved in said non-aqueous solvent, and a viscosity-reducing agent comprising impure 2-pentanone in sufficient quantity to substantially reduce the viscosity of the electrolyte below the viscosity of the non-aqueous solvent.

32. The electrolyte of claim 30, wherein said viscosity-reducing agent comprises about 1 to about 45% by volume of methyl isobutyl ketone (MIBK) impurity.

33. The electrolyte of claim 32, wherein said viscosity-reducing agent comprises about 5 to about 10% MIBK by volume.

34. The electrolyte of claim 33, wherein said salt is a combination of an anion selected from perfluoro anions and perfluoro, organic sulfonates and a cation selected from ethylated or methylated ammonium or pyridinium.

35. The electrolyte of claim 34, wherein said salt is tetraethyl ammonium tetrafluoroborate, pyridinium tetrafluoroborate, or methyl triethyl ammonium tetrafluoroborate.

36. The electrolyte of claim 35, wherein said salt is tetraethyl ammonium tetrafluoroborate.

37. The electrolyte of claim 36, wherein said organic solvent is selected from the group consisting of linear ethers, cyclic ethers, esters, carbonates, formates, lactones, nitrites, dinitriles, amides, sulfones and sulfolanes.

38. The electrolyte of claim 37, wherein said organic solvent is selected from the group consisting of PC and GBL.
